(19) United States
(12) Patent Application Publication
(10) Pub. No.: US 2012/0310509 A1
(43) Pub. Date: Dec. 6, 2012

(54) Dual fuel engine system

(75) Inventors: Leo G. Pardo, Laguna Niguel, CA (US); John G. Berry, Ojai, CA (US); Uri Ranon, Irvine, CA (US)

(73) Assignee: Maxtrol Corporation and Eco Power Systems, LLC

(21) Appl. No.: 13/134,138

(22) Filed: May 31, 2011

(51) Int. Cl. F02D 41/30

(52) U.S. Cl. 701/104

(57) ABSTRACT

A dual fuel system employs a liquid fuel supply subsystem and a gaseous fuel supply subsystem for an engine. The liquid fuel supply subsystem supplies liquid fuel to the engine and an electronic control module is configured to control, via one or more liquid fuel control signals, the amount of liquid fuel supplied to the engine based on one or more sensor signals. A gaseous fuel supply subsystem is configured to supply gaseous fuel to the engine and an electronic controller subsystem responsive to liquid fuel control signal(s) determines, based on the liquid fuel control signals, a modified amount of liquid fuel and an amount of gaseous fuel to be supplied to the engine for dual fuel operation.

### BACKGROUND OF THE INVENTION

1. Field of the Invention

The present invention relates to the field of fuel systems for engines. The invention herein relates more particularly to a dual fuel system that combines a liquid fuel such as diesel fuel and a gaseous fuel such as natural gas.

2. Background Art

Dual fuel engines are disclosed for example, in U.S. Pat. Nos. 6,901,889; 7,270,089; and in U.S. Patent Publication No. 2010/0332106; and WO 2007/115594 all incorporated herein by this reference.

Such duel fuel engines often include a diesel engine operating on both diesel fuel and natural gas (e.g., CNG or LNG). The diesel fuel is usually delivered to a common rail and electronically controlled injectors or to unit injectors from a tank via pump(s) and valve(s) or via other components of a liquid fuel supply subsystem. The diesel fuel amount is controlled, in an unmodified engine, at least in part by a vehicle's electronic control module (ECM) based on a variety of sensor signals (accelerator pedal position, engine speed and position, exhaust gas characteristics, and the like).

Natural gas is supplied via high pressure direct injection into the cylinders or lower pressures to the intake manifold or otherwise into the engine. The amount of natural gas supplied is also electronically controllable via a metering device, gaseous fuel injector, or the like.

At some point, the amount of natural gas is adjusted and the amount of diesel fuel is adjusted so that only a very small amount of the diesel fuel is supplied to the engine in order to ignite the natural gas. In this “pilot ignited gaseous fuel mode”, the engine is fueled primarily by natural gas.

Thus, the amount of diesel fuel must be controllable by an after market dual fuel system. In one design, a controller is added which coordinates with the vehicle ECM to control the supply of diesel fuel supplied to the engine (typically via the injectors). See WO 2007/115594. Such systems can void the manufacturer's warranty and also suffer from several additional limitations.

In WO 2007/115594, a system is proposed that intercepts and interprets the sensor signals input into the ECM. Those sensor signals are then modified so the ECM provides a predetermined amount of diesel fuel to the engine in order to run in the pilot fuel supply mode. As stated in WO 2007/115594, sensor data signals supplied to the ECM and used by it to control operation of the diesel fuel injectors are intercepted and modified before being transmitted to the ECM. The ECM is, in essence, “tricked” into controlling the diesel fuel injectors to affect the pilot fuel supply mode during dual fuel operation.

Such a system can be highly complex. The gaseous fuel controller which intercepts and interprets the original equipment manufacturer's (OEM) ECM sensor signals has to be connected to numerous sensors such as the accelerator pedal position sensor, the engine position sensor, the intake manifold pressure sensor, the intake manifold temperature sensor, and other sensors such as a coolant temperature sensor, an ambient pressure sensor, an ambient temperature sensor, and a vehicle speed sensor in order to control both the amount of diesel fuel and natural gas supplied to the engine. Mapping or calculating the optimal ratio of diesel fuel and natural gas based on these sensor signals can be difficult. In general, the amount of fuel supplied to the engine in an unmodified engine based on the output of the sensors is deemed proprietary by the OEM. Complex algorithms are required to meter the appropriate amount of natural gas and diesel fuel under different operating conditions. See Patent Nos. 6,598,584 and 7,270,089 incorporated herein by this reference.

Furthermore, intercepting and interpreting sensor signals and/or “tricking” an OEM ECM may be deemed by the OEM and/or government agencies (for example, the E.P.A) as problematic and/or undesirable.

### SUMMARY OF THE INVENTION

The preferred system of the present invention does not need to be connected to any of the vehicle sensors and does not require complex algorithms which attempt to make sense of the sensor signals. A dual fuel system in accordance with the subject invention, in one preferred embodiment, is able to operate on 80% natural gas with no power loss on hills or during acceleration. The system is quickly installed and fairly inexpensive. The system does not void the engine warranty and requires no mechanical or electrical modifications to the original diesel engine or emission system.

In a preferred embodiment, instead of intercepting and attempting to interpret vehicle sensor signals, an electronic controller device is configured to intercept the actual diesel fuel control signals output by the ECM and then modifies those signals based on a desired ratio of natural gas to diesel fuel.

The invention features, in one version, a compression internal combustion system comprising an engine including one or more cylinders, a liquid fuel supply subsystem for supplying liquid fuel to the engine, and an electronic control module configured to control, via one or more liquid fuel control signals, the amount of liquid fuel supplied to the engine based on one or more sensor signals. For dual fuel operation, a gaseous fuel supply subsystem is added and configured to supply gaseous fuel to the engine. An electronic controller subsystem is responsive to one or more of the liquid fuel control signals and is configured to determine, based on the liquid fuel control signals, the amount of liquid fuel and gaseous fuel to be supplied to the engine for dual fuel operation. The liquid fuel supply subsystem is controlled to supply the determined amount of liquid fuel to the engine and the gaseous fuel supply subsystem is controlled to supply the determined amount of gaseous fuel to the engine.

In one example, the liquid fuel supply subsystem includes electronically controlled liquid fuel injectors and the electronic controller subsystem is wired to one or more pulse duration lines between the electronic control module and the liquid fuel injectors. The electronic controller subsystem then controls the liquid fuel supply subsystem by delivering modified pulse durations on one or more of the pulse durations lines to control one or more of the liquid fuel injectors.

In some embodiments, the gaseous fuel supply subsystem includes electronically controllable gaseous fuel injectors each opened and closed via signals from the electronic controller subsystem. Also, the electronic controller subsystem can be responsive to the vehicle sensor bus and configured to take a predetermined action if a fault condition is transmitted on the sensor bus. One predetermined action includes stopping the supply of gaseous fuel in response to a fault condition.

Preferably, the electronic controller subsystem controls the liquid fuel supply subsystem by delivering one or more modified liquid fuel control signals to the liquid fuel supply subsystem and the modified liquid fuel control signals are a predetermined percentage of the liquid fuel control signals output by the electronic control module to present a percentage X of liquid fuel to the engine. The electronic controller subsystem typically controls the gaseous fuel supply subsystem to supply 100-X % gaseous fuel to the engine.

The system may further include a display and the electronic controller subsystem is then configured to show, on the display, the determined amount of liquid fuel and the determined amount of gaseous fuel.

A compression internal combustion system in accordance with aspects of the invention features an engine, a liquid fuel supply subsystem for supplying liquid fuel to the engine, and an electronic control module configured to control, via one or more liquid fuel control signals, the amount of liquid fuel supplied to the engine based on one or more sensor signals. A gaseous fuel supply subsystem is configured to supply gaseous fuel to the engine, and an electronic controller subsystem is responsive to one or more of the liquid fuel control signals and configured to determine, based on the liquid fuel control signals, a modified amount of liquid fuel and an amount of gaseous fuel to be supplied to the engine for dual fuel operation. One or more modified liquid fuel control signals are delivered to the liquid fuel supply subsystem to control the liquid fuel supply subsystem and to supply the determined modified amount of liquid fuel to the engine. The gaseous fuel supply subsystem is controlled to supply the determined amount of gaseous fuel to the engine.

A dual fuel method in accordance with aspects of the invention features supplying liquid fuel to an engine via a liquid fuel supply subsystem, controlling, via one or more liquid control signals, the amount of liquid fuel supplied to the engine based on one or more sensor signals. A gaseous fuel supply subsystem is connected to the engine for dual fuel operation. One or more liquid fuel control signals are intercepted and the method includes determining, based on one or more intercepted liquid fuel control signals, a modified amount of liquid fuel and also an amount of gaseous fuel to be supplied to the engine in a dual fuel mode. The liquid fuel supply subsystem is controlled to supply the determined modified amount of liquid fuel to the engine and the gaseous fuel supply subsystem is controlled to supply the determined amount of gaseous fuel to the engine.

A dual fuel engine control system in accordance with the invention may feature a controllable gaseous fuel supply subsystem configured to supply gaseous fuel to an engine, and an electronic controller subsystem which is configured to intercept one or more liquid fuel control signals, to determine based on one or more of the intercepted liquid fuel control signals, a modified amount of liquid fuel and an amount of gaseous fuel to be supplied to the engine, to control the gaseous fuel supply subsystem to supply the determined amount of gaseous fuel to the engine, and to control liquid fuel supply subsystem to supply the determined modified amount of liquid fuel to the engine.

A dual fuel control method includes supplying gaseous fuel to an engine, intercepting one or more liquid fuel control signals, and determining, based on one or more intercepted liquid fuel control signals, an amount of liquid fuel and gaseous fuel to be supplied to the engine. The determined amounts of gaseous fuel and liquid fuel are supplied to the engine.

The invention further features a method of operating a compression ignition internal combustion engine having an electronic control module configured to control, via one or more control signals, the amount of liquid fuel delivered to the engine based on one or more sensor signals. One method includes intercepting one or more of the control signals, supplying the intercepted control signals to an electronic controller subsystem, and using the electronic controller subsystem to determine an amount of liquid fuel and an amount of gaseous fuel to be supplied to the engine based on the intercepted control signals.

### BRIEF DESCRIPTION OF THE DRAWINGS

Other objects, features and advantages will occur to those skilled in the art from the following description of a preferred embodiment and the accompanying drawings, in which:

FIG. 1 is a schematic block diagram showing the primary components associated with a dual fuel system in accordance with one example of the invention;

FIG. 2 is a flow chart depicting the primary steps associated with the calculations of the electronic control unit controller of FIG. 1 in order to remap the OEM fuel curve for dual fuel operations; and

FIG. 3 is a flow chart depicting the primary steps associated with the calculations of the electronic control unit controller of FIG. 1 for the amount of gaseous fuel of the engine in a dual fuel mode.

### DETAILED DESCRIPTION OF THE INVENTION

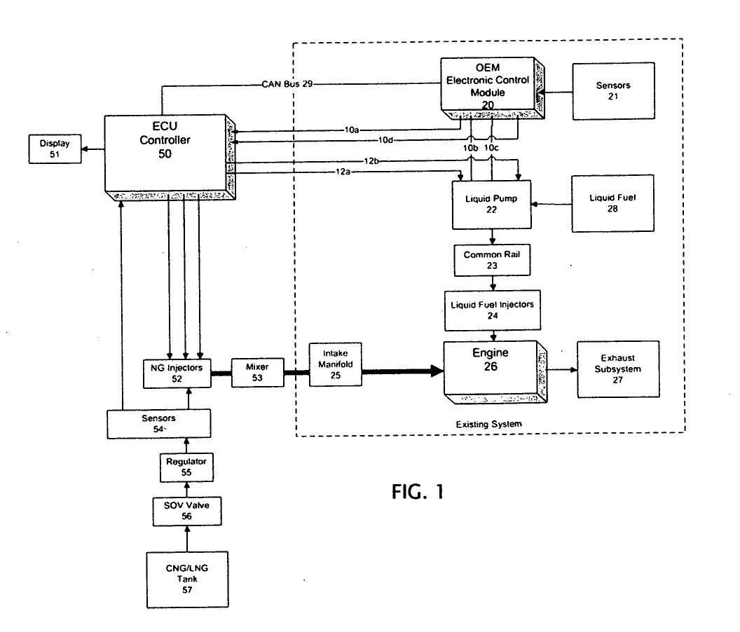

FIG. 1 depicts an example of a dual fuel system 10 for engine 26, typically a diesel engine or “compression internal combustion engine”. In some embodiments, there are a plurality of cylinders, with a piston in each cylinder defining a combustion chamber between a cylinder head and the piston. The piston is connected to a crank shaft in a conventional manner. Inlet and exhaust valves are provided and may be actuated by a cam shaft rotated by the crank shaft to control the supply of air/fuel mixture to and the exhaust of combustion products from the combustion chamber via exhaust subsystem 27. Gases may be supplied to and exhausted from engine 26 via an air intake manifold and an exhaust manifold. A turbo charger may be included as well.

In this example, there is a fuel supply subsystem whereby liquid fuel, e.g. diesel fuel, is presented to engine 26 from a tank 28 via pumps and the like represented at 22, in this example, to common rail supply 23 and injectors 24. In other embodiments, diesel fuel is supplied via unit injectors or a pump/nozzle supply system having multiple electronically controllable liquid fuel injectors. Various filters, pumps, high pressure release valves, pressure regulators and the like are also typically employed.

The amount of diesel fuel supplied to the engine cylinders is controlled by OEM ECM 20 based on the output of sensors 21. The sensor data may include an accelerator pedal position sensor, an engine position sensor, an intake manifold pressure sensor, an intake manifold temperature sensor, a coolant temperature sensor, an ambient pressure sensor, an ambient temperature sensor, a vehicle speed sensor, and the like. Sensor signals are typically transmitted on a CAN bus 29.

In one preferred embodiment, a second gaseous fuel source is added, e.g., CNG or LNG tank 57. The natural gas supply subsystem includes, in this particular design, various valves (Shut Off Valve, SOV) 56, a regulator 55 (controlling the pressure of the natural gas to 120 psi, for example), sensors 54 (typically for sensing temperature and pressure), and a controllable natural gas metering device such as injector subsystem 52. Other metering devices, gaseous fuel injectors, and the like may be used. In this particular example, natural gas then proceeds via mixer 53 into high pressure air intake 25 of engine 26. In other designs, a separate electronically actuated external injector can be provided for each cylinder or, in the case of a shared port intake system, for each pair of injectors or from a single point source for the entire engine. Natural gas can also be supplied to the air intake manifold as is known.

Electronic control unit controller 50 electronically controls the amount of natural gas supplied to the engine by opening and closing different combinations of injectors. In the example shown, there are three injectors.

Electronic control unit controller 50 functions to control the relative amounts of diesel fuel and natural gas presented to engine 26. As depicted, OEM ECM 20 outputs one or more diesel fuel control signals as shown in this example via different pulse durations on lines 10a, 10b, 10c, and 10d to pump solenoids 1, 2, 3 and 4 of the liquid fuel injector subsystem 24. As explained above, the pulse duration supplied on each line 10a-10d is a function of the sensor signals transmitted to ECM 20 and the map or fuel curve programmed into ECM 20. Such maps are typically proprietary.

Electronic control unit controller 50 is connected directly to one or more of the diesel fuel control signals output by ECM 20 as shown by line 10a and line 10d. Thus, one or more of the diesel fuel control signals output by ECM 20 are read by electronic control unit controller 50. Based on the pulse duration read on lines 10a and 10d, electronic control unit controller 50 determines the amount of diesel fuel and natural gas to be supplied to engine 26. Electronic control unit controller 50 controls, at least partially, the diesel fuel injectors by modifying the pulse duration on lines 12a and 12b to liquid pump 22, solenoids 1 and 4 (not shown) which results in the desired amount of diesel fuel injected into the engine by liquid fuel injector subsystem 24 for dual fuel operation. In this instance the liquid pump 22, has two solenoids 1 and 4 controlling 3 fuel injectors each. In other instances there is a direct connection from ECM 20 to each of the liquid fuel injectors 24 for each of the cylinders.

Electronic control unit controller 50 also controls injectors 1 through 3 (not shown) of the natural gas fuel supply subsystem as shown to meter the desired amount of natural gas into the engine for dual fuel operation.

As shown in Table 1, below, P_{ECM} is the pulse duration output by ECM 20 on lines 10a-10d for diesel fuel only operation. P_{ECU}, a modified pulse duration, is output by ECU controller 50 on lines 12a and 12b.

TABLE 1

| | P_{ECU} | | |
|---|---|---|---|
| P_{ECM} | (ECU | | |
| (ECM Pulse | Pulse | | |
| Duration) | Duration) | Gaseous Fuel Injectors | Condition |
| Short | Short | 1, 2, 3 closed, no NG | Idle |
| 25% max | 20% max | 1, 2, 3 open 5% | Cruise |
| | | equivalent of liquid fuel | Flat |
| 50% max | 25% max | 1, 2, 3 open 25% | Cruise |
| | | equivalent of liquid fuel | Slight grade |
| 100% max | 20% max | 1, 2, 3 open 80% | Steep grade or full |
| | | equivalent of liquid fuel | load |
| X | X | 1, 2, 3 closed | Fault condition |

When the pulse duration output by ECM 20 is short, the engine is idling and no natural gas is injected. Electronic control unit controller 50 presents an unmodified pulse duration P_{ECM} on line 12a and 12b and controls injector block 52 to close all three injectors in such an idling condition.

When P_{ECM} output by ECM 20 is at the maximum pulse duration (e.g., when the vehicle is driven with a load or up a steep uphill grade), electronic control unit controller 50 presents pulse durations on lines 12a and 12b that result in a signal of 20% of the fuel requested by ECM 20 generating P_{ECM} pulse duration signal 100 to engine 26 and 80% of the diesel equivalent natural gas supplied when electronic control unit controller 50 drives injectors 1, 2, and 3 of injector block 38. In the transition to this pilot fuel supply mode, the decrease in diesel fuel supplied and the increase in the amount of natural gas supplied, is preferably accomplished in a smooth fashion and typically occurs within one to two seconds.

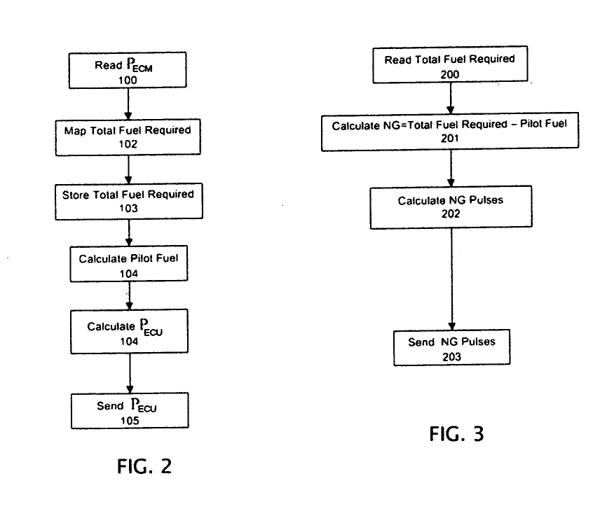

Table 1 also shows other natural gas and diesel fuel mixture possibilities. Typically, this remap of the fuel curve is accomplished by reading P_{ECM} output by OEM ECM 20 of FIG. 1, step 100 of FIG. 2 during various operating conditions and figuring out the amount of Total Fuel Required by ECM 20, using the OEM fuel curve, step 102. The Total Fuel Required value is stored, step 103. The ECU 50 then calculates a new Pilot Fuel, step 104, based on the amount Total Fuel Required and desired substitution. Then the ECU 50 converts the Pilot Fuel into a new P_{ECO} pulse, to be sent to the liquid pump 22. Electronic control unit controller 50 may be a microprocessor, microcontroller, or the like. Typically, the fuel map will be different for different vehicles, and even as between different versions of the same engine.

FIG. 3 shows calculation for the Gaseous fuel by taking Total Fuel Required 200 and subtracting the Pilot Fuel used for P_{ECO}, step 201. Based on the amount of diesel fuel being delivered to the engine, a desired substitution of diesel with natural gas is calculated or looked up and transmitted to the natural gas supply subsystem, step 202.

Table 1 depicts two additional conditions wherein all three natural gas injectors are closed and the pulse durations output by the OEM ECM are not modified. As shown in FIG. 1, electronic control unit controller 50 can be tapped into vehicle CAN bus 29 to read any fault signals transmitted over CAN bus 29. If a fault signals is detected, for example, an alternator fault condition, all three natural gas injectors of block 52 are closed and the diesel fuel control signals output by the electronic control module are not modified. The same condition is true if no natural gas is available, as for example, determined by sensors 54, FIG. 1.

FIG. 1 also shows a display 51 which can be mounted in the cabin of the vehicle to display, among other things, the ratio of diesel fuel to natural gas, the amount of natural gas remaining in the natural gas tank or tanks, and the like. Display 51 can be wired to electronic control unit controller 50 or wireless communications between electronic control unit controller 50 and display 51 can be used.

Thus it will be understood that what has been disclosed herein is a system for and method of operating a compression ignition internal combustion engine typically having an electronic control module configured to control, via one or more control signals, the amount of liquid fuel delivered to the engine based on one or more sensor signals. The liquid fuel control signals are intercepted and are provided to an after market electronic controller which determines the amount of liquid fuel and gaseous fuel to be supplied to the engine based on the intercepted liquid fuel control signals. Then, modified liquid control signals are supplied to the liquid fuel supply subsystem to change the amount of liquid fuel delivered to the engine and to supply the determined amount of gaseous fuel to the engine.

What is claimed is:

1. A compression internal combustion system comprising:
an engine including one or more cylinders;
a liquid fuel supply subsystem for supplying liquid fuel to the engine;
an electronic control module generating liquid fuel control signals to control the amount of liquid fuel supplied to the engine by the liquid fuel supply subsystem based on one or more sensor signals;
a gaseous fuel supply subsystem configured for supplying gaseous fuel to the engine; and
an electronic controller subsystem responsive to one or more said liquid fuel control signals and configured to determine a modified amount of liquid fuel and an amount of gaseous fuel to be supplied to the engine for dual fuel operation.

2. The system of claim 1 in which the liquid fuel supply subsystem comprises electronically controlled liquid fuel injectors.

3. The system of claim 2 in which the electronic controller subsystem is wired to one or more pulse duration lines between the electronic control module and the liquid fuel injectors.

4. The system of claim 3 in which the electronic controller subsystem controls the liquid fuel supply subsystem by delivering modified pulse durations on one or more said pulse duration lines to control one or more said liquid fuel injectors.

5. The system of claim 1 in which the gaseous fuel supply subsystem comprises electronically controllable gaseous fuel injectors each opened and closed via signals from the electronic controller subsystem.

6. The system of claim 1 further comprising a sensor bus and wherein the electronic controller subsystem is responsive to the sensor bus and configured to take a predetermined action if a fault condition is transmitted on the sensor bus.

7. The system of claim 6 in which one predetermined action includes stopping the supply of gaseous fuel in response to a fault condition.

8. The system of claim 1 in which the electronic controller subsystem controls the liquid fuel supply subsystem by delivering one or more modified liquid fuel control signals to the liquid fuel supply subsystem.

9. The system of claim 8 in which the modified liquid fuel control signals are a predetermined percentage of the liquid fuel control signals output by the electronic control module to present a percentage X of liquid fuel to the engine.

10. The system of claim 9 in which the electronic controller subsystem controls the gaseous fuel supply subsystem to supply 100-X % gaseous fuel to the engine.

11. The system of claim 1 further including a display and the electronic controller subsystem is configured to show, on the display, the amount of liquid fuel and the amount of gaseous fuel.

12. A dual fuel method comprising the steps of:
supplying liquid fuel to an engine via a liquid fuel supply subsystem;
generating one or more liquid fuel control signals to vary the amount of liquid fuel supplied to the engine by the liquid fuel supply subsystem based on one or more sensor signals;
intercepting one or more of said liquid fuel control signals;
connecting a gaseous fuel supply subsystem to the engine for operation in a dual fuel mode;
determining, based on one or more said intercepted liquid fuel control signals, a modified amount of liquid fuel and an amount of gaseous fuel to be supplied to the engine in a dual fuel mode;
controlling the liquid fuel supply subsystem to supply said determined modified amount of liquid fuel to the engine; and
controlling the gaseous fuel supply subsystem to supply said determined amount of gaseous fuel to the engine.

13. The method of claim 12 in which the liquid fuel supply subsystem comprises electronically controlled liquid fuel injectors.

14. The method of claim 13 comprising the step of wiring an electronic controller subsystem to one or more pulse duration lines connected to the liquid fuel injectors.

15. The method of claim 14 in which controlling the liquid fuel supply subsystem comprises the step of delivering modified pulse durations on one or more said pulse duration lines to control the injectors.

16. The method of claim 12 in which the gaseous fuel supply subsystem comprises electronically controllable gaseous fuel injectors and where the step of controlling the gaseous fuel supply comprises controlling said gaseous fuel injectors.

17. The method of claim 12 further detecting fault conditions and taking a predetermined action if a fault condition is detected.

18. The method of claim 17 in which one predetermined action includes stopping the supply of gaseous fuel in response to a fault condition.

19. The method of claim 12 further comprising the step of displaying the amount of liquid fuel and the amount of gaseous fuel.

20. A dual fuel engine control system comprising:
a controllable gaseous fuel supply subsystem configured to supply gaseous fuel to an engine; and
an electronic controller subsystem which:
intercepts one or more liquid fuel control signals; and
determines based on one or more of said intercepted liquid fuel control signals, a modified amount of liquid fuel and an amount of gaseous fuel to be supplied to the engine;
controls the gaseous fuel supply subsystem to supply said amount of gaseous fuel to the engine, and
controls a liquid fuel supply subsystem to supply said modified amount of liquid fuel to the engine.

21. The system of claim 20 in which the electronic controller subsystem is wired to one or more pulse duration lines connected to liquid fuel injectors of the engine.

22. The system of claim 21 in which the electronic controller subsystem controls the liquid fuel supply subsystem by delivering modified pulse durations on one or more said pulse duration lines to control the injectors.

23. A dual fuel system for an engine that normally operates on only one fuel; the system comprising:
a first fuel subsystem wherein a first fuel is supplied in an amount based upon first fuel control signals in response to sensors;
a second fuel subsystem which intercepts said first fuel control signals to reduce said amount of first fuel and provide a second fuel in lieu of the reduction of said first fuel.

24. The system of claim 23 wherein said first fuel control signals comprise electronic pulses of which the duration controls the amount of first fuel supplied to the engine.

25. The system of claim 24 further comprising an electronic control unit for calculating a modified pulse duration of said first fuel control signals for changing the amount of first fuel supplied to the engine.
